(19) United States
(12) Patent Application Publication
(10) Pub. No.: US 2008/0244978 A1
(43) Pub. Date: Oct. 9, 2008

(54) MOTORIZED SECURITY REVOLVING DOOR

(76) Inventor: Rahmi Soyugenc, Evansville, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/697,252

(22) Filed: Apr. 5, 2007

(51) Int. Cl. E05D 15/02

(52) U.S. Cl. 49/42

(57) ABSTRACT

A revolving door system includes a frame having first and second, opposing enclosure walls and a ceiling structure; a revolving door including central shaft with an axis and a plurality of panels hingedly connected together to the central shaft for rotation together about the axis; an access control system for signaling authorization to a control system upon provision of proper access data by a user; a detection system for detecting the presence of objects in specified zones proximal to at least one of the panels and including at least one fixed sensor mounted to the frame and at least one ride-along sensor mounted to the at least one the panels; motive means for rotating the door about the axis and, a control system connected with the detection system, access control system and motive means and operable to control rotation of the door about the axis in response to data from the detection system and the access control system.

### FIELD OF THE INVENTION

The present invention relates to revolving doors and, more particularly to motorized revolving doors with security apparatus to control access therethrough.

### BACKGROUND OF THE INVENTION

A motorized security revolving door is basically a standard motorized revolving door with the addition of an access control system, a detection system (to determine when a person(s) is attempting to pass through the door) and modifications to the door controller's software and/or hardware. A standard revolving door is typically divided into 3 or 4 compartments that are defined by wings or panels joined at a fixed angle at a common central rotating axis. A 4-wing door will have four compartments, a 3-wing door has three compartments, and so on. With a standard motorized revolving door, a person passes through the door by entering one of the open compartments and moving within that compartment until the door rotates far enough to allow exit from the compartment on the opposite side of the door. With a motorized security revolving door the sequence of events is the same with a few additions. First the person must be granted approval by the access control system and second the detection system must ensure that only the approved number of people pass through the door. The access control system is often two card readers (one on each side of the door) connected to a controller. The detection system is generally made up of sensors (infrared, ultrasonic, video or other) connected to the door controller.

There are two types of security violations encountered with security revolving doors. Tailgating is when one or more people enter a compartment that has not been approved for use by the access control system. A piggyback occurs when two or more people enter a compartment that has only been approved for one person. The detection system includes sensors mounted in the ceiling, over the wings, and ideally detect both tailgate and piggyback situations. To prevent the wing from being detected as a person, each sensor must be turned off or ignored when the wing passes below the sensor. Because of tolerances in the door's positioning system and tolerances in the sensor reaction time, the fixed, overhead sensors must be turned off or ignored several degrees before the wing reaches the sensor and must remain off several degrees after the sensor has passed. This creates areas or dead spots near the wings that are very difficult to cover.

What is need is a motorized security revolving door with improved coverage of the passenger compartment, as well as one enabling a non-secure mode.

### SUMMARY OF THE INVENTION

Generally speaking, there is provided a motorized security revolving door with an access control system that uses the combination of fixed and ride-along sensors to detect a the number and location of person(s) in the door's compartment. The invention also includes a non-secure operating mode with an option that allows the door to be operated as a standard motorized revolving door in non-secure operating mode. In addition, a safety system allows the wings to be collapsed at any time during non-secure operation.

A revolving door system includes a frame having first and second, opposing enclosure walls and a ceiling structure; a revolving door including central shaft with an axis and a plurality of panels hingedly connected together to the central shaft for rotation together about the axis; an access control system for signaling authorization to a control system upon provision of proper access data by a user; a detection system for detecting the presence of objects in specified zones proximal to at least one of the panels and including at least one fixed sensor mounted to the frame and at least one ride-along sensor mounted to the at least one the panels; motive means for rotating the door about the axis and, a control system connected with the detection system, access control system and motive means and operable to control rotation of the door about the axis in response to data from the detection system and the access control system.

It is an object of the present invention to provide an improved motorized security revolving door.

Other objects and advantages will become apparent from the following description of the preferred embodiment.

### BRIEF DESCRIPTION OF THE DRAWINGS

FIG. 1 is an elevational view of a motorized security revolving door system 10 in accordance with the present invention, and with a portion broken away to view motor 25.

FIG. 2 is a top plan, diagrammatic view of the door system 10 of FIG. 1.

FIGS. 3-5 are top plan, diagrammatic views of the door system 10 of FIG. 1, showing the collapsibility of door panels 31-34.

FIG. 6 is a segmented view of the upper portion of a panel 34 of the door system 10 of FIG. 1.

FIG. 7 is a top plan, diagrammatic view of the door system 10 of FIG. 1, and showing the control system 15.

FIGS. 8-10 are top plan, diagrammatic views of the door system 10 of FIG. 1, and showing the operation of detection system 14.

### DESCRIPTION OF THE PREFERRED EMBODIMENT

For the purposes of promoting an understanding of the principles of the invention, reference will now be made to the embodiments illustrated herein and specific language will be used to describe the same. It will nevertheless be understood that no limitation of the scope of the invention is thereby intended. Any alterations and further modifications in the described processes, systems or devices, and any further applications of the principles of the invention as described herein, are contemplated as would normally occur to one skilled in the art to which the invention relates.

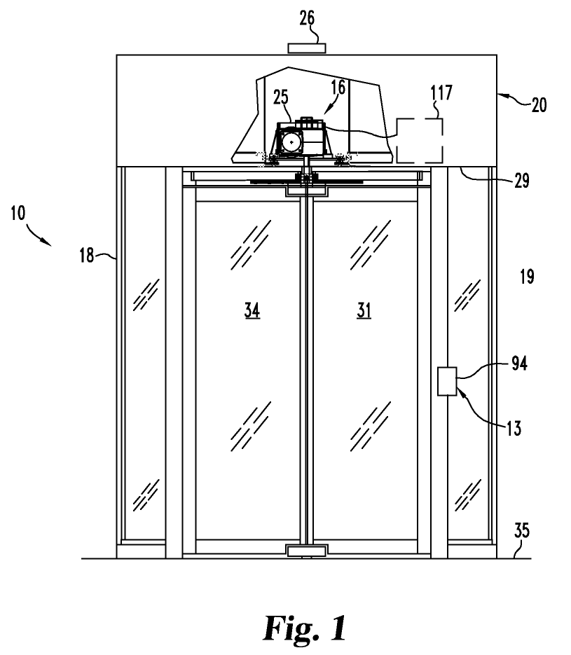

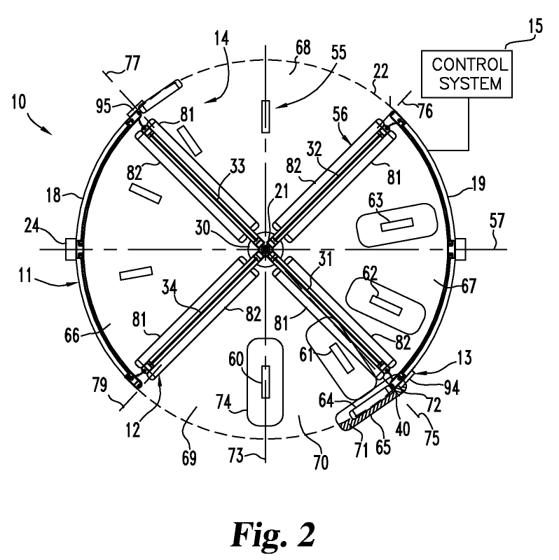

Referring to FIGS. 1 and 2, there is shown a motorized security revolving door system 10 in accordance with the present invention. Door system 10 generally includes a frame 11, a door 12, an access control system 13, a detection system 14, a control system 15 and motive apparatus 16. Frame 11 generally includes a pair of enclosure walls 18 and 19 and a cornice assembly 20. Enclosure walls 18 and 19 are mirror images of each other about door axis 21 and together define a frame circle 22. Because door 12 is a four panel door, enclosure walls 18 and 19 each define approximately 90 degrees of the frame circle. Each enclosure wall 18 and 19 is roughly the same height as door 12 and comprises an arcuate glass panel with a metallic border. Alternative embodiments are contemplated wherein enclosure panels are made of any desired material strong enough to provide the desired security for door system 10. Each enclosure wall 18 and 19 is mounted to a jamb member 24 of an adjacent wall (not shown) or similar structure. Motive apparatus 16 essentially includes a motor 25 for rotating door 12 about its axis 21. Cornice assembly 20 includes a ceiling (indicated at 29, FIG. 1) and houses motor 25 and other supporting elements of door system 10 and connects enclosure walls 18 and 19 together at their top edges. Frame 11 further includes a transom bar 26 for connection to surrounding structure, as needed.

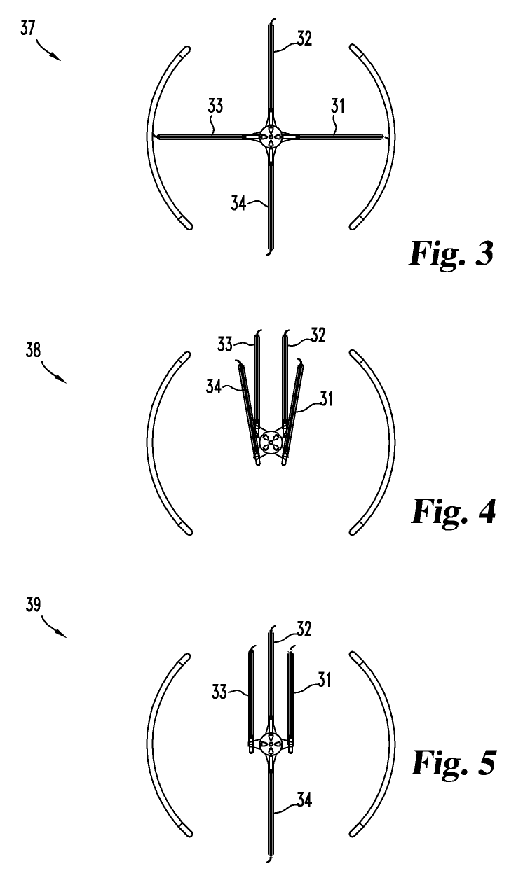

Door 12 includes a central shaft 30 and four identical panels 31-34 (also referred to herein as wings) mounted to central shaft 30 for rotation therewith about door axis 21 and within the frame 11, as shown. Central shaft 30 extends from the ground 35 up to cornice assembly where it connects with and is driven by motor 25. Panels 31-34 are hingedly mounted to central shaft 30 and are collapsible in the event of an emergency. That is, each panel 31-34 is connected to central shaft 30 by an appropriate connection device operable to hold the panel in a standard operating position 37 (FIG. 3) wherein each panel 31-34 extends radially outwardly from central shaft 30, and to allow one or more of the panels 31-34 to be manually forced to a non-radially extending, collapsed position 38 or 39 (FIGS. 4 and 5) in the event of a fire or other emergency situation. The amount of force required to collapse a panel 31-34 is set high enough to prevent nuisance collapses during normal operation, but to allow egress through door 12 in an emergency. Also, if someone gets caught between a panel 31-34 and a wall post 40 of an enclosure wall 19 (a wall post event), applying sufficient force to the corresponding panel will collapse the panel to free the trapped person. This mechanical remedy is intended to be a backup means of freeing the person in the event of a power failure or similar event. The primary means is to prevent a wall post event via detection system 14, which includes electronic systems with sensors to detect a wall post event, stop the door and/or, if necessary, reverse the door.

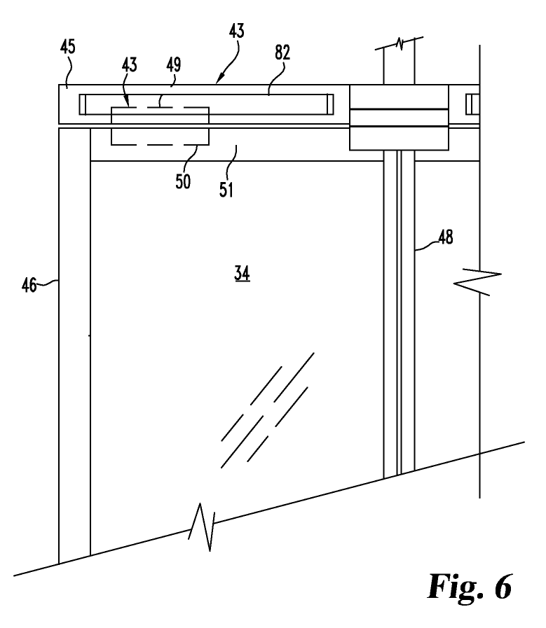

Referring to FIG. 6, to provide collapsibility of panels 31-34, door 12 further including a magnetic panel locking system 43 that includes for each panel 31-34 an electro-magnetic lock assembly 44. Panel 34 (identical to panels 31-33) includes a carrier arm 45 and a panel member 46 aligned directly therebelow. Panel member 46 is hingedly connected to central shaft 30, as is known with such doors, and carrier arm 45 is fixedly connected to central shaft 30. In one embodiment, lock assembly comprises an electromagnet assembly, such as a Securitron (Securitron, 550 Vista Blvd. Sparks, Nev.) Shear Aligning Magnalock Part No. SAM 12/24 VDC, having a 1200 lb breaking force threshold. The magnets ensure that the panels 31-34 cannot be broken during normal secure operation. Even without the magnets, panels 31-34 are not easily broken, but with the magnets engaged it is virtually impossible to break any of the panels 31-34 over to the collapsed position (38/39). The “magnets” are actually comprised of two parts—an electromagnet 49 and an armature plate 50, which is made of material to allow maximum attraction to electromagnet 49. Electromagnet 49 is mounted to carrier arm 45, and armature plate 50 is located inside the top rail 51 of panel member 46. During normal secure operation, panels 31-34 are not collapsible as this could allow unauthorized access through door 12. Electromagnets 49 hold panels 31-34, via armature plates 50, securely in place. During a safety event (such as fire alarm) the electromagnets 49 must be de-energized to allow panels 31-34 to collapse. When the panels 31-34 are not “broken” away, they are directly under their associated carrier arm 45. When the electromagnets are then energized, the armature plates 50 in the panels 31-34 are attracted to the electromagnets in the carrier arm 45, locking the panels 31-34 in the radial position. In one embodiment, collapsible panels 31-34 are mechanically connected with central shaft 30 via a spring-biased detent assembly (not shown) comprising a bronze V-slot and Delrin® plunger as is known for connecting such door panels for collapsing operation. The V-slot has a 60° slope. The spring force in such detent assembly is adjustable and, in one embodiment, is set at approximately 75 lbs. to overcome the detent and manually collapse one or more of the panels. Such configuration holds each panel securely in its standard operating position 37 to central shaft 30 and, during non-secure operation (with the electromagnets 49 de-energized so the panels could otherwise be collapsed at any time), permits one or more of the panels 31-34 to be collapsed if sufficient force is applied. Such configuration provides backup breakaway ability for a fire alarm or wall post event.

Referring to FIG. 2, detection system 14 generally includes a plurality of fixed sensors (as at 55) and a plurality of ride-along sensors (as at 56). The fixed sensors 55 are located in the ceiling 29, above door 12, but one or more can be mounted elsewhere (for example, in the floor or outside of frame circle 22). The location of the fixed sensors 55 is approximate and more sensors may be used than shown. In revolving door system 10, there are ten fixed sensors 55, five each on opposing sides of the lateral midline 57 of frame 11: an entrance sensor 60, first, second and third compartment sensors 61-63, and a doorjamb sensor 64. Sensors 55 are any appropriate sensor operable to detect presence within a defined zone and are contemplated to include, without limitation, infrared, ultrasonic and/or video sensors, which are commonly known in the art. A compartment is generally the pie-shaped region bounded by a pair of adjacent wings (e.g. panels 34 and 31 or 31 and 32) and the enclosure wall boundary. Enclosure sectors 66 and 67 are the opposing pie-shaped regions bounded by enclosure walls 18 and 19 and radial lines 75-78 extending from door axis 21 to the outer edges (as at 40) of walls 18 and 19. Entrance sectors 68 and 69 are the remaining pie-shaped regions defined by frame circle 22 and corresponding lines 75-78, as shown. The enclosure wall boundary is generally the frame circle 22, but may extend outside of frame circle 22 to include any region covered by a sensor that extends outside frame circle 22, but not radially outside of either enclosure wall 18 or 19. For example, if doorjamb sensor 64 has a sensor zone 65 that extends outside of frame circle 22, the corresponding compartment 70 there includes that portion 67 that extends outside of frame circle 22, but not that portion 72 radially outside of wall 19. Entrance sensor 60 is mounted roughly along the longitudinal midline 73 of frame 11 and somewhat near frame circle 22. Entrance sensor 60 detects when a person has entered the entry compartment 70, which signal is processed by control system 15 to start rotating door 12. The sensor detection zone 74 (the region passing into which activates the sensor) of sensor 60 (and all sensors contemplated herein) may be fixed or adjustable. First, second and third compartment sensors 61-63 are mounted nearer to frame circle 22 than to central shaft 21, with first sensor 61 located in entrance sector 69, about 10 degrees clockwise of wall edge radius 78 (as viewed in FIG. 2). Second and third sensors 62 and 63 are located in enclosure sector 67, also near edge wall radius 78, with second sensor 62 located about 20 degrees counterclockwise of wall edge radius 78 and third sensor 63 located about 20 degrees counterclockwise of lateral midline 57. Sensor 64 is located near wall post 40, proximal frame circle 22 to detect a wall post event and contribute to detecting a presence in entrance sector 69. The sensor zones of sensors 60-64 are shown surrounding each sensor (as at 74 for sensor 60). Fixed sensors 60-64 detect the presence of persons entering door 12 through entrance sector 69, and are mirror images about lateral midline 57 of the remaining five of fixed sensors 55.

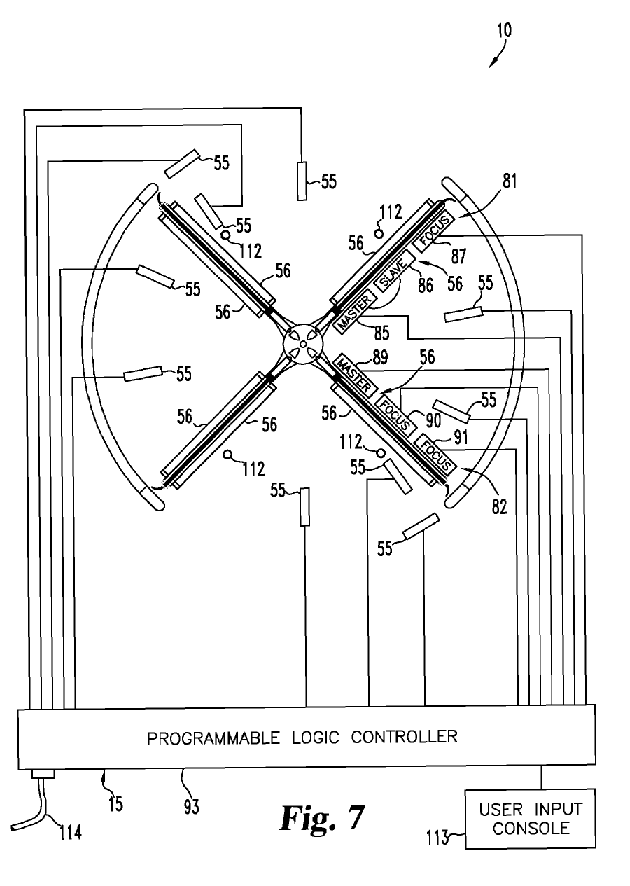

The ride-along sensors 56 include for each door panel 31-34 a compartment front panel sensor 81 and a compartment back panel sensor 82, which are mounted to the carrier arms 45 of each panel 31-34. The carrier arms 45, panels 31-34 and compartment panel sensor 81 and 82 all rotate together as door 12 turns. In one embodiment, fixed sensors 55 are BEA Focus II active infrared sensors, and compartment panel sensors 81 and 82 are a BEA Superscan I and a BEA Superscan II door mounted, infrared presence sensor, respectively, from BEA Inc., RIDC Park West, 100 Enterprise Drive, Pittsburgh, Pa. Sensor 81 contains three sensor units: a master 85, a slave 86 and a BEA Focus II sensor 87, and sensor 81 contains three sensor units, a master 89 and two BEA Focus II sensors 90 and 91, all as shown diagrammatically in FIG. 7. The BEA Superscan I and Superscan II sensors are adjustable, and the detection range of both sensors 81 and 82 is adjustable to over 8 feet down, which enables the zones of sensors 81 and 82 to be variably set, including to just above the floor (i.e. ground 35) of a typical 7′ to 9′ door 12. Such adjustment also includes the zone being set right up next to the door panel and/or out at a desired angle.

The access control system includes two card readers 94 and 95, one on each side of the door 12, which are operationally connected to control system 15. Card readers 94 and 95 are any appropriate card reader capable of enabling a user to swipe, move or otherwise engage a security card or similar item through or proximal to the card reader to gain authorization and access to the door system 10. Alternative embodiments are contemplated wherein the access control system 13 uses a more remote activator, such as and without limitation, an electronic actuator similar to those use to activate auto alarm systems. Alternative embodiments are contemplated wherein the access control system 13 includes any suitable apparatus for providing proper access data by a user, such as and without limitation, a keypad device to enable access in lieu of or in addition to the apparatus described above, which signals authorization to control system 15.

Tailgating is when one or more people enter a compartment that has not been approved for use by the access control system 13. With a fixed sensor system, the sensors are strategically placed so the user must pass the sensor to get through the door. The problem with fixed sensors is they must be turned off or ignored when the wing passes the sensor. The sensor must turn off several degrees before the wing reaches the sensor and must remain off several degrees after the sensor has passed to prevent detecting the wing as a person. A thin person staying very close to the wing can in some cases pass through the door undetected. Ride-along sensors, which provide excellent coverage of the area near the wings, can eliminate this means of undetected access. Adjusting the ride-along sensors 56 to cover the area near the wings leaves the center of the compartment (e.g. midway between the opposing wings of a compartment), especially near the enclosure wall 18 or 19, with inadequate coverage. In addition to using ride-along sensors 56, strategically locating a fixed sensor 63 where the person must pass the sensor 63 before gaining access to the opposite side of the door guarantees the center of the compartment will be adequately covered.

The control system 15 includes any appropriate computer system that is programmed to receive electronic signals from access control system 13 and detection system 14 and to operate as described herein. For example, upon detection of a piggyback event, motor 25 is commanded by control system 15 to stop, trapping person therein until security can assess any security risk, or simply to reverse to allow the unapproved person to exit. Alternative embodiments are contemplated wherein the computer system comprises a with a programmable logic controller 93.

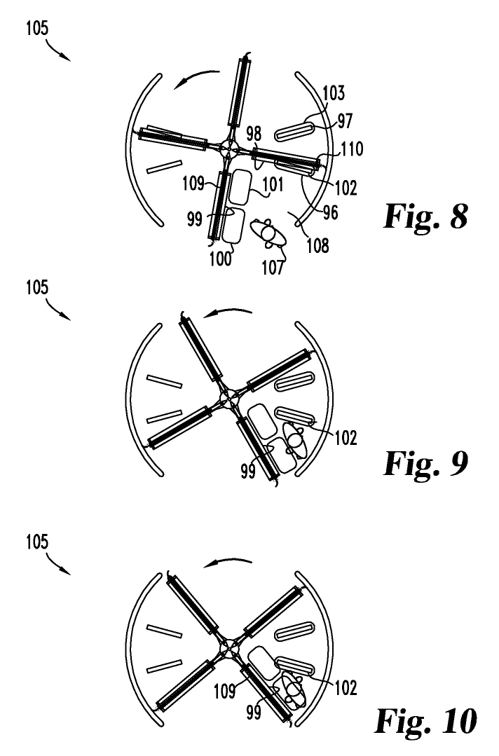

Referring to FIGS. 8-10, a door system 105 is shown with an alternative configuration of just two fixed sensors 96 and 97 (for each direction of travel through the door) and where the compartment front and back, ride-along sensors 98 and 99 each contain only two sensor units (a master sensor and a slave sensor), each creating two coverage zones (those for sensor 99 shown at 100 and 101). The coverage zones for sensors 96 and 97 are indicated at 102 and 103, respectively. FIGS. 8-10 show how the combination of fixed and ride-along sensors are used to detect a person 107 trying to pass through the door. The person 107 enters the door. As the compartment 108 rotates past the first fixed sensor 102, the person 107 is forced past the sensor 102 by the rear wing 109 of compartment 108 (FIG. 9). The person will pass fixed sensor 102 before the front wing 110 of compartment 108 progresses far enough to let the person through to the other side of the door. Consequently, the door can be stopped if the person is in a compartment that is not approved. Notably, the ride-along sensors 98 and 99 will detect a person trying to stay close to a wing 109 (FIG. 10) to avoid detection by the fixed, ceiling sensors.

A piggyback occurs when two or more people enter a compartment that has only been approved for one person. In a door system with fixed sensors only, the first fixed sensor must turn off several degrees before the wing reaches the sensor and must remain off several degrees after the sensor has passed to prevent detecting the wing as a person. If a thin person stays very close to the front wing of the compartment and another stays close to the rear wing, one or both may otherwise be able to avoid detection by fixed sensors. If the compartment has been approved for one person, then only one of the two persons needs to pass through undetected. A combination of ride-along sensors and fixed sensors as described herein better detect when two people are in the compartment. If the compartment's front wing and rear wing ride-along sensors are activated simultaneously for set period, it is a good indication that more than one person is in the compartment. The ride-along sensors can be directed downwards to cover just the area near the wings to prevent false piggyback detection. For piggyback detection, each wing needs at least two sensors, an inner sensor and an outer sensor. If the following combination of sensors is on simultaneously for a set period, a piggyback alert is issued: front outer sensor ON and back outer sensor ON; front outer and back inner ON, or front inner and back outer ON.

The operation of door system 10 is contemplated to be operable in a manner similar to that described for door system 105, and/or in any other manner suitable for detecting piggybacking and/or tailgating. That is, the fixed and ride-along sensors are positioned to detect unauthorized and multiple entries, to process such data, and to cause motor 25 to move or cease moving, accordingly.

Control system 15 also includes a plurality of indicator lights 112 mounted in the ceiling 54 (FIG. 7), which are turned on by control system 15 in a flashing (or non-flashing, as desired) mode upon occurrence of an event (piggybacking, tailgating, wall post event or other selected event). Control systems 15 is contemplated to also include other desired signaling devices, as desired, (not shown), such as sirens, beepers, etc. to signal an event occurrence. Door system 10 also includes standard lighting (as at 116) in the ceiling 29, as desired to provide standard illumination.

Control system 15 further includes power connection and control elements 114 operable to connect with and accept power from an external power source and to provide it to the various components of door system 10, as needed, such as motor 25 and the computer system (not shown) of control system 15. Control system 15 also includes connections for connection to an external control system, for example, an existing building security system. Alternative embodiments are contemplated wherein control system 15 also includes a user input console 113, which enables a non-secure mode for motorized security revolving door 10. Console 113 allows a user to select between secure and non-secure modes, as well as to view and manipulate current and historical operational data and status, to change passwords and/or modify programming. Appropriate programming for door system 10 operates as follows: as a security revolving door, door 12 receives a start signal from the access control system 13 once a valid user has been approved. Detection system 14 then ensures only the approved number of people enter through door 12. In a non-secure mode, detection system 14 functions as a start signal for the door. When detection system 14 detects a person entering entrance sector 69, for example, door control system 15 starts rotating the door 12.

Motor 25 is the type having a gearbox and a controllable braking system (not shown) that allows motor 25 to be back driven. In one embodiment, motor 25 is a SCR rated permanent magnet field DC motor. Motor 25 is connected in combination with a regenerative motor controller, which is contained within a control box 117 (FIG. 1), which also contains the computer control system 15 for the logic of door system 10. Motor 25 also includes a worm and worm gear design gear train in combination therewith. Revolving door 12 can be operated as either a motorized security revolving door in secure mode or as a standard motorized revolving door in non-secure mode. Back driven means motor 25 does not drive door 12, but instead is driven by door 12 in a manual mode. Manual rotation of door 12 by a person spins the armature of motor 25. When drive motor 25 is off, it requires about as much force for a person to manually rotate door 12 as it does to rotate a standard non-motorized door. The gearbox (not shown) of motor 25 is a helical/bevel gearbox, which allows the motor to be back driven.

A security revolving door that is always operated in a secure mode is typically for applications where the same people use the door on a regular basis and are familiar with its operation. In secure mode a security card is generally required to use the door. Use of door system 10 in a non-secure mode is contemplated for use in applications where the general public use the door, at least part of the time.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A revolving door system, comprising:
a frame including first and second, opposing enclosure walls and a ceiling structure;
a revolving door including a central shaft with an axis and a plurality of panels hingedly connected together to the central shaft for rotation together about the axis;
an access control system for signaling authorization to a control system upon provision of proper access data by a user;
a detection system for detecting the presence of objects in specified zones proximal to at least one of the panels and including at least one fixed sensor mounted to said frame and at least one ride-along sensor mounted to the at least one the panels;
motive means for rotating said door about the axis; and
a control system connected with said detection system, access control system and motive means and operable to control rotation of said door about the axis in response to data from said detection system and said access control system.
